(19) United States
(12) Patent Application Publication
(10) Pub. No.: US 2026/0057767 A1
(43) Pub. Date: Feb. 26, 2026

(54) SYSTEM AND METHOD FOR DETECTING SPEED ANOMALIES IN A CONNECTED VEHICLE INFRASTRUCTURE ENVIRONMENT

(71) Applicant: Yunex LLC, Wilmington, DE (US)

(72) Inventors: Priscilla BOYD, Austin, TX (US); Pratik SHIVARKAR, Austin, TX (US)

(21) Appl. No.: 19/372,202

(22) Filed: Oct. 28, 2025

Related U.S. Application Data
(63) Continuation of application No. 17/262,543, now Pat. No. 12,505,737.

(51) Int. Cl. G08G 1/052; G01S 19/13; G08G 1/01

(52) U.S. Cl. CPC G08G 1/052; G01S 19/13; G08G 1/0112; G08G 1/0116; G08G 1/0125

(57) ABSTRACT

A system for detecting speed anomalies in a connected vehicle infrastructure environment includes a plurality of roadside units configured to collect vehicle traffic data from vehicles travelling in a road network; a vehicle traffic data evaluation module configured to receive collected vehicle traffic data from the plurality of roadside units, the vehicle traffic data comprising multiple data sets of multiple vehicles, extract first data from the collected vehicle traffic data, combine and/or conform the first data with second data, create vehicle profiles based on combined and/or conformed first data and second data and road segment profiles based on clustering and filtering of the vehicle profiles, compare a first vehicle profile of the collected vehicle traffic data with a road segment profile, and detect and output an anomaly of the first vehicle profile when the first vehicle profile is outside a predefined threshold.

### CROSS-REFERENCE TO RELATED APPLICATIONS

This Application is a continuation under 35 U.S. C. § 120 of U.S. patent application Ser. No. 17/262,543, filed on Jan. 22, 2021, which is national stage entry under 35 C.F. R. § 371 of PCT Application No. PCT/US2019/053747, filed on Sep. 30, 2019, the entire contents of each of which are hereby incorporated by reference.

### BACKGROUND

### Field

Aspects of the present disclosure generally relate to traffic management and traffic monitoring, and more specifically, to systems and methods for detecting speed anomalies in a connected vehicle infrastructure environment.

### Description of Related Art

In general, traffic management and monitoring systems collect and/or process information regarding traffic conditions. Collected and/or processed information may be utilized for reasons related to safety, efficiency, environmental concerns, and other issues, such as for example for detecting road hazards or unusual behavior of vehicles in a road network. Currently, incident detectors and queue detectors exist which can help to identify unexpected queues that may relate to incidents. However, known incident and queue detectors are hardware-based, using technologies such as magnetometers, microwave radar, inductive loops, and cameras. Another known method is by detecting incidents through user reports, for example by using mobile software applications such as “Waze.” However, such user reports need to be actively reported by motorists and cyclists. Thus, improved traffic management and monitoring is desirable.

### SUMMARY

Briefly described, aspects of the present disclosure relate to a system and a method for detecting speed anomalies in a connected vehicle infrastructure environment. Collected traffic information can be used for different purposes, such as for example for detecting unusual behavior of vehicles in a road network, including for example speed anomalies of vehicles. These speed anomalies may relate to harsh braking which, when clustered in patterns, may relate to road hazards or near misses, or may relate to harsh accelerating which, when clustered in patterns, may indicate areas of reckless driving.

A first aspect of the present disclosure provides a system for detecting speed anomalies in a connected vehicle infrastructure environment comprising a plurality of roadside units installed at different locations within a road network, each roadside unit comprising a wireless receiver and configured to collect, via the wireless receiver, vehicle traffic data from vehicles travelling in a road network; a vehicle traffic data evaluation module comprising at least one processor configured via executable instructions to receive collected vehicle traffic data from the plurality of roadside units, the vehicle traffic data comprising multiple data sets of multiple vehicles, extract first data from the collected vehicle traffic data, combine and/or conform the first data with second data, create vehicle profiles based on combined and/or conformed first and second data and road segment profiles based on clustering and filtering of the vehicle profiles, compare a first vehicle profile of a first vehicle of the collected vehicle traffic data with a road segment profile, and detect and output an anomaly of the first vehicle profile of the first vehicle when the first vehicle profile is outside a predefined threshold.

A second aspect of the present disclosure provides a method for detecting speed anomalies in a connected vehicle infrastructure environment comprising through operation of at least one processor receiving vehicle traffic data provided by a plurality of roadside units, the vehicle traffic data comprising multiple data sets of multiple vehicles, extracting first data from the collected vehicle traffic data, combining and/or conforming the first data with second data, creating vehicle profiles based on combined and/or conformed first data with second data and road segment profiles based on clustering and filtering of the vehicle profiles, comparing a first vehicle profile of a first vehicle of the collected vehicle traffic data with a road segment profile, and detecting and outputting an anomaly of the first vehicle profile of the first vehicle when the first vehicle profile is outside a predefined threshold.

A third aspect of the present disclosure provides a non-transitory computer readable medium encoded with processor executable instructions that when executed by at least one processor, cause the at least one processor to carry out a method for detecting speed anomalies in a connected vehicle infrastructure environment as described herein.

### DESCRIPTION OF THE DRAWINGS

FIG. 1 illustrates a simplified block diagram of an onboard unit of a vehicle in accordance with an exemplary embodiment of the present disclosure.

FIG. 2 illustrates a simplified block diagram of a roadside unit in accordance with an exemplary embodiment of the present disclosure.

FIG. 3 illustrates a schematic diagram of a system for detecting speed anomalies in a connected vehicle infrastructure environment in accordance with an exemplary embodiment of the present disclosure.

FIG. 4 illustrates a flow chart of a method for detecting speed anomalies within a connected vehicle infrastructure environment in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being systems and methods for detecting speed anomalies in a connected vehicle infrastructure environment. Embodiments of the present disclosure, however, are not limited to use in the described systems, devices, or methods. The present disclosure relates to finding new uses for connected vehicle data, provided by onboard units installed within vehicles, wherein roadside units retrieve and store standardized data and information from the onboard units of the vehicles.

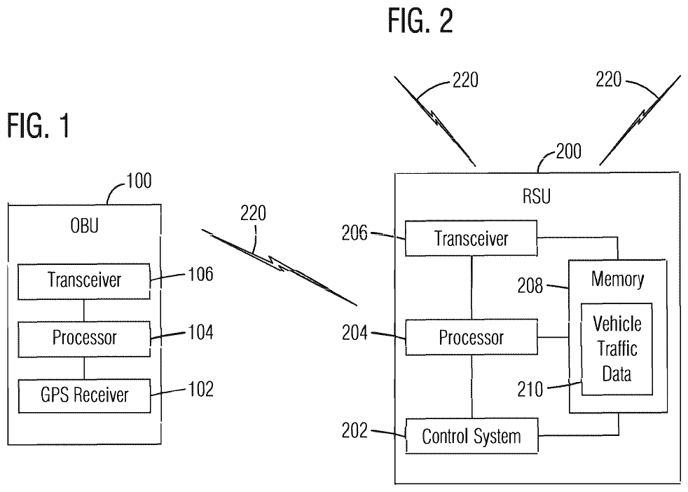

FIG. 1 illustrates a simplified block diagram of an onboard unit 100, herein also referred to as OBU 100, of a vehicle in accordance with an exemplary embodiment of the present disclosure. A vehicle includes many types of motor vehicles that travel within a road network, such as cars, trucks, buses, etc. The OBU 100 is installed in a vehicle and comprises processor 104 connected between a Global Positioning System (GPS) receiver 102 and a transceiver 106. The processor 104 receives geographic location of the GPS receiver 102 and precise time of day, updated continually or periodically. The GPS receiver 102 receives the geographic location and time from the GPS. The GPS is well known and will not be described herein in detail.

Further data, such as vehicle identification data and vehicle speed data can be recorded by the OBU 100. The processor 104 transmits at least the location data, time data, and speed data to the transceiver 106, which transmits the location data, time data, and speed data wirelessly to a roadside unit (RSU) 200 (see FIG. 2). In this manner, the RSU 200 receives continuous updates of the geographic location at a precise time and speed for every vehicle approaching from each direction that is within the broadcast area of the respective transceivers 106.

Those of skill in the art will recognize that not all details are shown in the simplified diagram of FIG. 1. For example, GPS receiver 102 may also be connected to an automobile navigation system, an emergency-communication system, or to other components of the automobile. The GPS receiver 102, processor 104, and transceiver 106 may each also be connected to a vehicle power source and/or to other systems and components of the vehicle. The processor 104, and other components, can be configured to read and write to a storage such as volatile and non-volatile memory, magnetic, optical, or solid-state media, or other storage devices. Processor 104 may be configured to perform only the processes described herein or can also be configured to perform other processes for the operation and management the vehicle. The various components of FIG. 1 may be constructed as separate elements configured to communicate with each other, or two or more of these components may be integrated into a single device.

FIG. 2 illustrates a simplified block diagram of an RSU 200, in accordance with an exemplary embodiment of the present disclosure. Processor 204 of RSU 200 is connected between a control system 202 and a transceiver 206. The transceiver 206 receives data and information from multiple transceivers 106 of multiple OBUs 100, including for example, location data, time data, speed data, and/or vehicle identification data etc. of multiple uniquely-identified vehicles, updated continually or periodically, illustrated via elements 220. The received data and information are herein referred to as vehicle traffic data 210. As FIG. 2 shows, the RSU 200 may receive information and data from multiple OBUs 100 of multiple vehicles.

The transceiver 206 provides received vehicle traffic data 210 to the processor 204, and the processor 204 then sends the data and information to the control system 202. The control system 202 may analyze or process and utilize the information and data for example for traffic control and management processes. Further, the RSU 200 comprises at least one memory 208, volatile or non-volatile, for storing the vehicle traffic data 210 received from the OBUs 100 of the multiple vehicles. The processor 204 is configured to read and write to the memory 208, wherein the vehicle traffic data 210 including location data, time data, speed data, and other data provided by OBUs 100 are stored in the memory 208.

Those of skill in the art will recognize that not all details are shown in the simplified diagram of FIG. 2. For example, control system 202, processor 204, and transceiver 206 are each also connected to a power source and may each be connected to other systems and components. The processor 204 may be configured to perform only the processes described herein or can also be configured to perform other processes for the operation and management of the RSU 200. The various components of FIG. 2 can be constructed as separate elements configured to communicate with each other, or two or more of these components could be integrated into a single device. For example, processor 204 can be an integral part of the control system 202 and perform many or all of the functions of the RSU 200.

In an embodiment, wireless transmission between OBUs 100 and RSUs 200 can be performed via dedicated short-range communications (DSRC). Further, multiple OBUs 100 may communicate with each other (with other OBUs 100) via DSRC, and multiple RSUs 200 may communicate with each other (with other RSUs 200) via DRSC. In other embodiments, the OBUs 100 and RSUs 200 may communicate via a wireless communication link, such as for example wireless local area network (LAN) (over Internet access point), cellular/mobile network(s) or other radio technology, such as for example via cellular vehicle-to-everything (V2X) or via standard long-term evolution (LTE) (3^{rd} Generation (3G)/4^{th} Generation (4G)).

Some or all the components of the RSU 200 can be physically located other than “roadside,” such as in a traffic cabinet, traffic controller, signal head, or otherwise. The RSU 200 can be used to control many different types of traffic equipment and can be used to collect and send data to a central monitoring station for further analysis or action, using common networking and communication techniques.

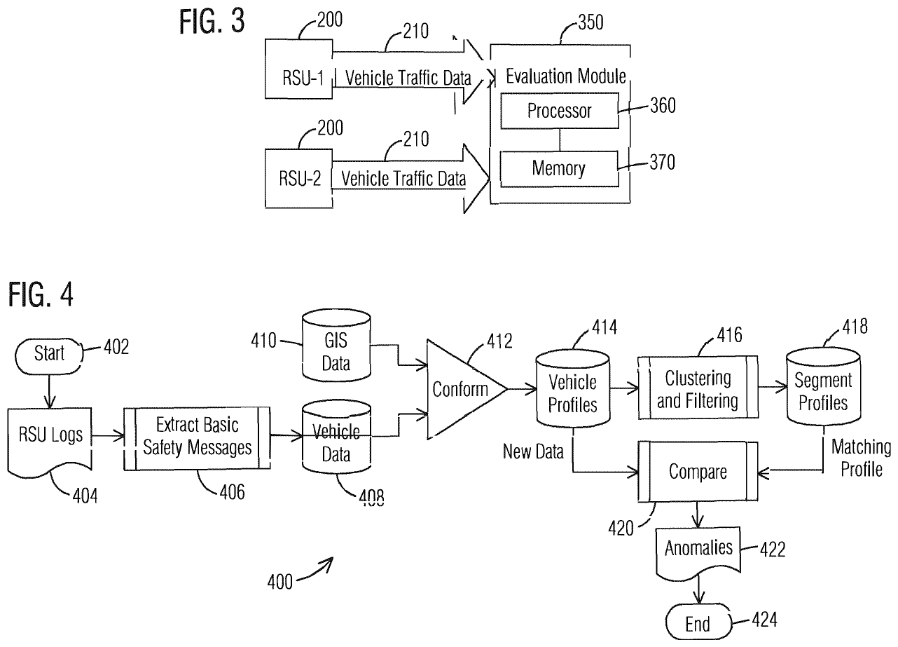

FIG. 3 illustrates a schematic diagram of a system 300 for detecting speed anomalies in a connected vehicle infrastructure environment in accordance with an exemplary embodiment of the present disclosure. Generally, the system 300 includes multiple RSUs 200, such as RSU-1 and RSU-2, the RSUs 200 may be configured, for example, as described with respect to FIG. 2.

Further, system 300 includes vehicle traffic data evaluation module 350, herein also referred to as evaluation module 350, comprising at least one processor 360 and a memory 370, wherein the vehicle traffic data evaluation module 350 is configured to receive and process vehicle traffic data 210 provided by RSU-1 and RSU-2. Although system 300 illustrates only two RSUs 200, the vehicle traffic data evaluation module 350 may receive or collect and process data from many RSUs 200.

In exemplary embodiments, the memory 370 may include any of a wide variety of memory devices including volatile and non-volatile memory devices, and the at least one processor 360 may include one or more processing units.

The vehicle traffic data evaluation module 350 may be embodied as software or a combination of software and hardware. The vehicle traffic data evaluation module 350 may be a separate module or may be an existing module programmed to perform a method as described herein. For example, the vehicle traffic data evaluation module 350 may be incorporated, for example programmed, into an existing traffic management or monitoring device, by means of software.

The memory 370 of the evaluation module 350 includes software with a variety of applications. One of the applications includes a method for detecting speed anomalies in a connected vehicle infrastructure environment. In certain embodiments, the at least one processor 360 of the evaluation module 350 is configured, via executable instructions, to collect or receive and process and analyze vehicle traffic data 210 and detect and output speed anomalies, as described herein. It is noted that the at least one processor 360 may be configured to perform only the process(es) described herein or may also be configured to perform other processes.

In general, the at least one processor 360 is configured to receive collected vehicle traffic data 210 from the plurality of RSUs 200. The vehicle traffic data 210 comprise multiple data sets of multiple vehicles. The at least one processor 360 is further configured to extract first data from the collected vehicle traffic data 210, combine the first data with second data, create vehicle profiles and segment profiles based on combined first and second data, compare a first data set of a first vehicle of the collected vehicle traffic data with the vehicle profiles, and detect and output an anomaly of the first data set of the first vehicle when the first data set is outside a predefined threshold.

FIG. 4 illustrates a flow chart of a method 400 for detecting speed anomalies within a connected vehicle infrastructure environment in accordance with an exemplary embodiment of the present disclosure. While the method 400 is described as a series of acts that are performed in a sequence, it is to be understood that the method 400 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The method may start at 402. At 404, the vehicle traffic data 210, embodied for example as RSU logs (roadside unit logs), which include data sets of multiple vehicles, are received by the evaluation module 350 for processing and evaluating. For example, the evaluation module 350 may collect the RSU logs from the RSUs 200 via a communications link, wired or wireless, for example via an Ethernet cable or other suitable means to connect with the RSUs 200. The RSU logs may be collected by the evaluation module 350 itself in an automated manner, for example periodically. In another embodiment, the RSU logs may be transferred manually to the evaluation module 350.

The method 400 may include an act (or process) 406 of extracting data from the vehicle traffic data 210. Specifically, act 406 comprises extracting basic safety messages, herein referred to as BSM or BSMs, from the RSU logs. A basic safety message is a standardized message set specified by the Society of Automotive Engineers (SAE) standards including a standardized set of data. The basic safety message standard is specified in SAE J2735. Each basic safety message includes data and information, including for example data of GPS location, speed, date, and time of the respective vehicle that recorded these data in its OBU 100 (see FIG. 1). In an example, an OBU 100 may generate and transmit about 10 basic safety messages per second, for example to an RSU 200, which are then further transmitted to the evaluation module 350. Considering the amount of about 10 basic safety messages per second and per vehicle, the RSU 200 collects a large amount of data (RSU logs) and in turn the evaluation module 350 processes and evaluates a large amount of data.

From the extracted BSMs, vehicle data 408, including speed, GPS location, date, and time are used for further processing. These vehicle data 408 are herein referred to as first data.

The method 400 further comprises an act 412 of combining and/or conforming the first data with geographic information system (GIS) data 410, also referred to herein as second data. Specifically, the second data comprises GIS data 410 or derivations of GIS data 410. For example, GIS data 410 may be interpolated since interpolated GIS data 410 may be more suitable for the described method. In embodiments, GIS data 410 including GIS line-string data, e.g., such as those provided by OpenStreetMap®, Google Maps®, HERE®, INRIX®, are used, wherein the first data are paired with specific segments of a road. This means that the vehicle data 408 are placed in a specific road segment in accordance with corresponding location data, date/time data, and speed data recorded by an OBU 100 of a respective vehicle. By combining and/or conforming the vehicle data 408 with the GIS data 410, vehicle profiles 414 are created or generated.

The method 400 may further comprise an act 416 of creating road segment profiles 418 for a given road segment based on speed, location, date, and time provided by the BSMs of the multiple vehicles. Specifically, the road segment profiles 418 comprise speed segment profiles which are created by clustering and filtering of the vehicle profiles 414, which are based on speed, location, date, and time information combined with the GIS data 410, utilizing for example an unsupervised clustering method. Such an unsupervised clustering method may be for example k-means clustering. It should be noted that k-means clustering will not be described in detail herein as those skilled in the art are familiar with this method.

Once the road segment profiles 418 are created (using a sufficient amount of data sets of vehicles), new vehicle traffic data, e.g. a new vehicle profile 414 is compared with established road segment profiles 418, see act 420. In an exemplary embodiment of the present disclosure, a (new) vehicle profile 414 is paired and/or compared with a road segment profile 418 using discrete Frechet distance. The Frechet distance is known in the field of mathematics and thus will not be explained in detail herein. Frechet distance can be used as a measure between curves. In our example, a road segment profile 418 (e.g., such as a speed segment profile) can be considered a first curve. Then, new vehicle data 408, considered as a second curve, is compared with the first curve (road segment profile 418). The comparing is performed by applying discrete Frechet distance that is based on a threshold of a reduction in speed. When the second curve lies outside the Frechet distance based on the threshold, a speed anomaly 422 is detected and output by the evaluation module 350. Detected speed anomalies 422, when clustered in patterns, may relate to road hazards or near misses (harsh braking), or to reckless driving (harsh acceleration). In an example, the threshold of the reduction in speed comprises a 50% reduction in speed. In other examples, the threshold may comprise more or less than 50% reduction in speed, for example 40% or 60%. Thus, sudden drops in speed, for example, due to sudden braking or deceleration of the vehicle, can be detected. At 424, the method 400 may end.

It should be appreciated that the described method 400 may include additional acts and/or alternative acts corresponding to the features described previously with respect to the system 300 and evaluation module 350 (see FIG. 3).

The described system 300 and method 400 provide an algorithm designed for detecting a speed anomaly using a combination of machine learning, e.g. k-means clustering, and a statistical approach which is the discrete Frechet distance. A new use case for connected vehicle data is described, allowing road authorities to utilize generated data by leveraging connected vehicle infrastructure investments. Further, the provided system 300 and method 400 reduce the need for road authorities to invest on dedicated detection infrastructure, enabling the same use case to be catered for with data and machine learning instead, thereby reducing overall cost of ownership of a similar solution for incident detection. The provided solution opens opportunities for detection of near misses which may not usually get reported by citizens or road users. Such near misses may indicate underlying patters for potential unsafe areas, enabling road authorities to proactively verify hotspots that could reduce accidents and thus help, for example, with the US Department of Transportation's “Vision Zero” initiatives. Further, data and information relating harsh acceleration, which may relate to reckless driving, can help cities identify areas where enforcement should be supplied in order to avoid or reduce reckless driving behavior which may end up in accidents or incidents on the road network.

The approach is designed with minimum data of the Basic Safety Messages, e.g., speed, GPS location, data and time. This preserves user privacy at the core while helping to create or support functionalities to increase safety on roads.

It should be appreciated that acts associated with the above-described methodologies, features, and functions (other than any described manual acts) may be carried out by one or more data processing systems, such as for example evaluation module 350, via operation of at least one processor 360. As used herein, a processor corresponds to any electronic device that is configured via hardware circuits, software, and/or firmware to process data. For example, processors described herein may correspond to one or more (or a combination) of a microprocessor, central processing unit (CPU), or any other integrated circuit (IC) or other type of circuit that is capable of processing data in a data processing system. As discussed previously, the processor 360 that is described or claimed as being configured to carry out a particular described/claimed process or function may correspond to a CPU that executes computer/processor executable instructions stored in a memory in the form of software and/or firmware to carry out such a described/claimed process or function. However, it should also be appreciated that such a processor may correspond to an IC that is hard wired with processing circuitry (e.g., a field programmable gate array (FPGA) or application specific integrated circuit (ASIC) IC) to carry out such a described/claimed process or function.

In addition, it should be understood that a processor that is described or claimed as being configured to carry out a particular described/claimed process or function may correspond to the combination of the processor 360 with the executable instructions (e.g., software/firmware apps) loaded/installed into a memory (volatile and/or non-volatile), which are currently being executed and/or are available to be executed by the processor 360 to cause the processor 360 to carry out the described/claimed process or function. Thus, a processor that is powered off or is executing other software, but has the described software installed on a data store in operative connection therewith (such as on a hard drive or solid-state drive (SSD)) in a manner that is set up to be executed by the processor (when started by a user, hardware, and/or other software), may also correspond to the described/claimed processor that is configured to carry out the particular processes and functions described/claimed herein.

Further, it should be understood, that reference to “a processor” may include multiple physical processors or cores that are configured to carry out the functions described herein.

It is also important to note that while the disclosure includes a description in the context of a fully functional system and/or a series of acts, those skilled in the art will appreciate that at least portions of the mechanisms of the present disclosure and/or described acts are capable of being distributed in the form of computer/processor executable instructions (e.g., software and/or firmware instructions) contained within a data store that corresponds to a non-transitory machine-usable, computer-usable, or computer-readable medium in any of a variety of forms. The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, Julia, C, C #, C++, Scala, R, MATLAB, Clojure, Lua, Go or any other form of code that can be programmed/configured to cause at least one processor to carry out the acts and features described herein. Still further, results of the described/claimed processes or functions may be stored in a computer-readable medium, displayed on a display device, and/or the like.

1. A method for detecting speed anomalies in a connected vehicle infrastructure environment comprising:
generating a plurality of vehicle profiles for a plurality of vehicles, each respective vehicle profile of the plurality of vehicle profiles comprising first vehicle data for a respective vehicle of the plurality of vehicles across a plurality of road segments;
for a first road segment of the plurality of road segments:
filtering the plurality of vehicle profiles to identify data corresponding to the first road segment; and
clustering the data corresponding to the first road segment to generate a first road segment profile that comprises a speed profile for the first road segment; and
providing, as output, an indication of a speed anomaly based on a comparison of the first road segment profile to second vehicle data for a second vehicle, wherein the second vehicle data is associated with the first road segment.

2. The method of claim 1, wherein generating the plurality of vehicle profiles comprises:
for each respective vehicle of the plurality of vehicles:
obtaining first data comprising speed data, location data, date data, and time data for the respective vehicle over a period of time; and
combining the first data with second data to generate the first vehicle data for the respective vehicle, the second data comprising geographic information system (GIS) data associated with the plurality of road segments.

3. The method of claim 2, wherein combining the first data with the second data comprises associating the first data with one or more road segments of the plurality of road segments.

4. The method of claim 2, wherein obtaining the first data for the respective vehicle comprises obtaining the first data from one or more roadside units of a plurality of roadside units installed at different locations within the connected vehicle infrastructure environment.

5. The method of claim 2, wherein the first data for the respective vehicle comprises one or more basic safety messages associated with the respective vehicle.

6. The method of claim 1, further comprising:
obtaining first data for the second vehicle, the first data comprising speed data, location data, date data, and time data for the second vehicle associated with the first road segment; and
combining the first data with second data to generate the second vehicle data, the second data comprising geographic information system (GIS) data associated with the first road segment.

7. The method of claim 1, wherein providing, as the output, the indication of the speed anomaly based on the comparison comprises providing, as the output, the indication of the speed anomaly based on the second vehicle data not satisfying a threshold relative to the first road segment profile.

8. The method of claim 7, wherein:
the threshold comprises a threshold Frechet distance; and
the method further comprises:
representing the first road segment profile as a first curve of speed over the first road segment;
representing the second vehicle data as a second curve of speed over the first road segment; and
determining a Frechet distance as a measure between the first curve and the second curve; and
providing, as the output, the indication of the speed anomaly based on the second vehicle data not satisfying the threshold relative to the first road segment profile comprises providing, as the output the indication of the speed anomaly based on the Frechet distance not satisfying the threshold Frechet distance.

9. The method of claim 8, wherein the threshold Frechet distance is based on a threshold reduction in speed of the second vehicle relative to the speed profile of the first road segment profile.

10. The method of claim 9, further comprising determining the first road segment comprises one or more road hazards based on at least the indication of the speed anomaly.

11. The method of claim 8, wherein the threshold Frechet distance is based on a threshold of increase in speed of the second vehicle relative to the speed profile of the first road segment profile.

12. The method of claim 11, further comprising determining the first road segment is associated with reckless driving based on at least the indication of the speed anomaly.

13. A processing system comprising: memory comprising computer-executable instructions; and one or more processors configured to execute the computer-executable instructions and cause the processing system to:
generate a plurality of vehicle profiles for a plurality of vehicles, each respective vehicle profile of the plurality of vehicle profiles comprising first vehicle data for a respective vehicle of the plurality of vehicles across a plurality of road segments;
for a first road segment of the plurality of road segments:
filter the plurality of vehicle profiles to identify data corresponding to the first road segment; and
cluster the data corresponding to the first road segment to generate a first road segment profile that comprises a speed profile for the first road segment; and
provide, as output, an indication of a speed anomaly based on a comparison of the first road segment profile to second vehicle data for a second vehicle, wherein the second vehicle data is associated with the first road segment.

14. The processing system of claim 13, wherein to generate the plurality of vehicle profiles, the one or more processors are configured to execute the computer-executable instructions and cause the processing system to:
for each respective vehicle of the plurality of vehicles:
obtain first data comprising speed data, location data, date data, and time data for the respective vehicle over a period of time; and
combine the first data with second data to generate the first vehicle data for the respective vehicle, the second data comprising geographic information system (GIS) data associated with the plurality of road segments.

15. The processing system of claim 14, wherein to combine the first data with the second data, the one or more processors are configured to execute the computer-executable instructions and cause the processing system to associate the first data with one or more road segments of the plurality of road segments.

16. The processing system of claim 14, wherein to obtain the first data for the respective vehicle, the one or more processors are configured to execute the computer-executable instructions and cause the processing system to obtain the first data from one or more roadside units of a plurality of roadside units installed at different locations within a connected vehicle infrastructure environment.

17. The processing system of claim 14, wherein the one or more processors are configured to execute the computer-executable instructions and cause the processing system to:
obtain first data for the second vehicle, the first data comprising speed data, location data, date data, and time data for the second vehicle associated with the first road segment; and
combine the first data with second data to generate the second vehicle data, the second data comprising geographic information system (GIS) data associated with the first road segment.

18. The processing system of claim 14, wherein to provide, as the output, the indication of the speed anomaly based on the comparison, the one or more processors are configured to execute the computer-executable instructions and cause the processing system to provide, as the output, the indication of the speed anomaly based on the second vehicle data not satisfying a threshold relative to the first road segment profile.

19. The processing system of claim 18, wherein:
the threshold comprises a threshold Frechet distance; and
the one or more processors are configured to execute the computer-executable instructions and cause the processing system to:
represent the first road segment profile as a first curve of speed over the first road segment;
represent the second vehicle data as a second curve of speed over the first road segment; and
determine a Frechet distance as a measure between the first curve and the second curve; and
to provide, as the output, the indication of the speed anomaly based on the second vehicle data not satisfying the threshold relative to the first road segment profile, the one or more processors are configured to execute the computer-executable instructions and cause the processing system to provide, as the output the indication of the speed anomaly based on the Frechet distance not satisfying the threshold Frechet distance.

20. A non-transitory computer-readable medium comprising executable instructions that, when executed by one or more processors of an apparatus, cause the apparatus to perform operations comprising:
generating a plurality of vehicle profiles for a plurality of vehicles, each respective vehicle profile of the plurality of vehicle profiles comprising first vehicle data for a respective vehicle of the plurality of vehicles across a plurality of road segments;
for a first road segment of the plurality of road segments:
filtering the plurality of vehicle profiles to identify data corresponding to the first road segment; and
clustering the data corresponding to the first road segment to generate a first road segment profile that comprises a speed profile for the first road segment; and
providing, as output, an indication of a speed anomaly based on a comparison of the first road segment profile to second vehicle data for a second vehicle, wherein the second vehicle data is associated with the first road segment.
